SEQUENCE LISTING (3 sequences)

SEQ ID NO: 1 - protein, 274 aa, Homo sapiens
MVGRRALIVLAHSERTSFNYAMKEAAAAALKKKGWEVVESDLYAMNFNPIISRKDITGKLKDPANFQYPAESVLAYKEGHLSPDIVAEQKKLEAADLVIFQFPLQWFGVPAILKGWFERVFIGEFAYTYAAMYDKGPFRSKKAVLSITTGGSGSMYSLQGIHGDMNVILWPIQSGILHFCGFQVLEPQLTYSIGHTPADARIQILEGWKKRLENIWDETPLYFAPSSLFDLNFQAGFLMKKEVQDEEKNKKFGLSVGHHLGKSIPTDNQIKARK

SEQ ID NO: 2 - protein, 234 aa, Pseudomonas aeruginosa PAO1
MNVLIVHAHNEPQSFTRALCDQACETLAGQGHAVQVSDLYAMNWNPVASAADFAERADPDYLVYALEQRESVKRQSLAADIQAELDKLLWADLLILNFPIYWFSVPAILKGWFDRVLVSGVCYGGKRFYDQGGLAGKKALVSLTLGGRQHMFGEGAIHGPLEDMLRPILRGTLAYVGMQVLEPFVAWHVPYISEEARGNFLRAYRARLENLEQDVPLRFPRLEQFDALLQPLAR

SEQ ID NO: 3 - protein, 188 aa, Escherichia coli K12
MSEKLQVVTLLGSLRKGSFNGMVARTLPKIAPASMEVNALPSIADIPLYDADVQQEEGFPATVEALAEQIRQADGVVIVTPEYNYSVPGGLKNAIDWLSRLPDQPLAGKPVLIQTSSMGVIGGARCQYHLRQILVFLDAMVMNKPEFMGGVIQNKVDPQTGEVIDQGTLDHLTGQLTAFGEFIQRVKI

(19) United States
(12) Patent Application Publication
(10) Pub. No.: US 2020/0157474 A1
(43) Pub. Date: May 21, 2020

(54) MULTI-COMPONENT DETERGENTS OR CLEANSERS CONTAINING A QUINONE OXIDOREDUCTASE

(71) Applicant: Henkel AG & Co. KGaA

(72) Inventors: Christian DEGERING, Erkrath (DE); Michael DREJA, Neuss (DE); Susanne WIELAND, Dormagen (DE)

(21) Appl. No.: 16/690,238

(22) Filed: Nov. 21, 2019

(30) Foreign Application Priority Data
Nov. 21, 2018 (DE) 10 2018 129 277.5

(51) Int. Cl. C11D 3/386; C11D 3/20; C11D 3/395

(52) U.S. Cl. CPC C11D 3/38681; C11D 3/2072; C11D 3/395; C11D 11/0017; C12Y 106/99005; C12Y 101/01049; C11D 3/2096

(57) ABSTRACT

Detergents or cleansers may include at least one quinone oxidoreductase, an NAD(P)H cofactor, and a first substrate for the quinone oxidoreductase. The quinone oxidoreductase may be spatially separated from the NAD(P)H cofactor and/or first substrate. The detergent or cleanser may also include at least one inhibitor of the quinone oxidoreductase. A method for washing textiles or automatic dishwashing using this detergent or cleanser is also disclosed.

### CROSS-REFERENCE TO RELATED APPLICATION

The present application claims priority to German Patent Application Serial No.: 10 2018 129 277.5 according to 35 U.S.C. § 119, which was filed on Nov. 21, 2018; which is incorporated herein by reference in its entirety and for all purposes.

### TECHNICAL FIELD

The present invention relates to detergents or cleansers which comprise at least one enzyme (A) as defined herein, NAD(P)H as cofactor (B) and optionally at least one associated substrate (C) as defined herein, wherein the component (A) exists spatially separated from the components (B) and (C) and/or the detergent further comprises at least one substance (A-I) which acts as an inhibitor of the enzyme (A). The invention further relates to the use of the detergent or cleanser for washing textiles or automatic dishwashing, and to a method for washing textiles or automatic dishwashing using this detergent.

### BACKGROUND

Enzyme-containing bleach is known in the art, but is currently hardly used commercially in detergent and cleanser applications. While solid detergents which comprise chemical bleaching systems are widely used in the market, liquid detergents seldom contain a bleaching system. In the field of cleansers and institutional hygiene, the only solutions currently commercially available are those with dispersed solid bleach (PAP). Alternatively, there are cartridge systems in which two formulations are dosed separately, usually one with detergent and one with bleach (based on H₂O₂).

Previous bleaching based on enzymes and enzymatic systems have the disadvantage that the performance or the spectrum of action is very limited. For example, laccases show advantages on individual bleachable stains. Marketable peroxidases (DuPont) require a high amount of substrate (about 4 molecules of glucose per 1 molecule of generated H₂O₂), which make the application uneconomical. It would be advantageous if the substrate could be reused during use or converted into a useful ingredient.

There is therefore a need for enzymatic bleaching systems with broad effectiveness, high (molecular) efficiency and good stability which are suitable for use in liquid detergents and cleansers.

### SUMMARY

It has now been found that an enzymatic system which contains a quinone oxidoreductase with associated cofactor NAD(P)H and a suitable substrate, and optionally another enzyme with a substrate for regenerating the cofactor, exhibits good bleaching performance on a variety of stains and has high stability in liquid detergents and cleansers.

A first object is therefore a detergent or cleanser, characterized in that the detergent or cleanser contains:

(A) at least one quinone oxidoreductase;

(B) NAD(P)H as cofactor; and

(C) optionally at least one substrate for the enzyme (A);

wherein either the component (A) is spatially separated from the components (B) and optionally (C), or the detergent or cleanser further comprises (A-I) at least one substance which acts as an inhibitor for the enzyme (A).

In another aspect, use of such multi-phase detergents or cleansers for laundering textiles or automatic dishwashing is disclosed.

Finally, methods for washing textiles or automatic dishwashing, characterized in that in at least one method step a detergent or cleanser is used as described herein.

These and other aspects, features, and advantages of the invention will become apparent to a person skilled in the art through the study of the following detailed description and claims. Any feature from one aspect of the invention can be used in any other aspect of the invention. Furthermore, it will readily be understood that the examples contained herein are intended to describe and illustrate but not to limit the invention and that, in particular, the invention is not limited to these examples. Unless indicated otherwise, all percentages are indicated in terms of wt.-%. Numerical ranges that are indicated in the format “from x to y” also include the stated values. If several preferred numerical ranges are indicated in this format, it is self-evident that all ranges that result from the combination of the various endpoints are also included.

This subject matter covers all conceivable types of detergents or cleansers, both concentrates and undiluted detergents or cleansers, for use on a commercial scale, in washing machines or for hand washing or cleaning. These include detergents or cleansers for textiles, carpets, or natural fibers, for which the term detergent or cleanser is used. These include, for example, dishwashing detergents for dishwashers or manual dishwashing detergents or cleansers for hard surfaces such as metal, glass, porcelain, ceramics, tiles, stone, painted surfaces, plastics, wood or leather, for which the term cleanser is used, i.e. in addition to manual and mechanical dishwashing detergents also scouring detergents or cleansers, glass cleansers, WC toilet scented cleaners, etc. The detergents or cleansers also include auxiliary detergents or cleansers which are added to the actual detergent or cleanser during manual or automatic textile washing in order to achieve a further effect. Furthermore, detergents or cleansers also include textile pre-treatment and post-treatment detergents or cleansers, i.e. those detergents or cleansers with which the item of laundry is brought into contact before the actual washing cycle, for example to loosen stubborn stains, and also those detergents or cleansers which give the laundry further desirable properties such as a pleasant feel, wrinkle resistance or low static charge in a step subsequent to the actual textile washing step. Inter alia, softeners are included in the aforementioned detergents or cleansers.

### DETAILED DESCRIPTION

“At least one” as used herein includes, but is not limited to 1, 2, 3, 4, 5, 6 and more. In relation to an ingredient, the expression refers to the type of ingredient and not to the absolute number of molecules. “At least one substrate” thus means, for example, at least one type of substrate, i.e. that one type of substrate or a mixture of a plurality of different substrates may be meant. Together with weight specifications, the expression relates to all compounds of the type indicated that are contained in the composition/mixture, i.e. that the composition does not contain any other compounds of this type beyond the amount of the corresponding compounds indicated.

When reference is made herein to molar masses, this information always refers to the number-average molar mass Mₙ, unless explicitly indicated otherwise. The number-average molecular mass can, for example, be determined by gel permeation chromatography (GPC) according to DIN 55672-1:2007-08 with THF as the eluent. The weight-average molar mass M_{w} can also be determined by means of GPC just as described for Mₙ.

“Liquid,” as used herein, includes liquids and gels as well as paste-like compositions. The liquid compositions may be flowable and pourable at room temperature, but it is also possible that they have a yield point.

The term “spatially separated” with respect to the compositions as used herein means that the compositions can not come into contact with each other prior to use. Typically, the detergent or cleanser is provided in a multi-compartment package such as a bottle or pouch, particularly a two-chamber bottle or a two-chamber pouch, with each composition being separated from the other respective composition(s) in a separate chamber.

The detergent or cleanser is described in more detail below is characterized in that the detergent or cleanser contains at least one quinone oxidoreductase (A). In various embodiments, the enzyme (A) is a two-electron oxidoreductase. In particular, the enzyme (A) is a quinone oxidoreductase which is able to catalyze the hydrogenation of quinones to form stable hydroquinone intermediates while consuming NADPH (nicotinamide adenine dinucleotide phosphate) or NADH (nicotinamide adenine dinucleotide) as an enzymatic cofactor. However, there are certain compounds whose hydrogenation does not lead to stable intermediates, but instead to unstable hydroquinone intermediates which, in the presence of atmospheric oxygen, spontaneously release a superoxide anion radical (O₂⁻), in turn forming unstable semiquinone intermediates which, with the release of another superoxide anion radical (O₂⁻), then spontaneously regenerate the starting compound. Such compounds are also defined as an “enzyme (A)-activated substrate” and may be used as substrates. Suitable compounds are described herein. In an aqueous environment, superoxide anion radicals disproportionate, giving off oxygen and forming hydroxide and hydrogen peroxide. Thus, using a detergent or cleanser as described herein, it is possible to incorporate enzymatically-supplied bleach-active hydrogen peroxide into a wash liquor.

In various embodiments, the enzyme (A) contained in the detergent or cleanser comprises or consists essentially of or consists of the amino acid sequence given in SEQ ID NO: 1, 2 or 3. In various further embodiments, the detergents or cleansers comprise at least one enzyme (A) which is derived from the amino acid sequence according to SEQ ID NO: 1, 2 or 3, for example by means of mutagenesis. In various further embodiments, detergents or cleansers comprise at least one enzyme (A) which is obtainable by the expression of a nucleotide sequence which codes for a protein according to SEQ ID NO: 1, 2 or 3. In a further embodiment, the enzyme (A) comprises an amino acid sequence which, over its entire length, is at least 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 98.8%, 99.0%, 99.2%, 99.4% or 99.6% identical to the amino acid sequence given in SEQ ID NO:1, SEQ ID NO:2 or SEQ ID NO:3 or consists of such a sequence.

In various embodiments, the detergents or cleansers contain the at least one enzyme (A) in an amount of 0.00001 to 10 wt.-%, such as in an amount of 0.0002 to 0.8 wt.-%, based respectively on the total weight of the detergent or cleanser. The above amounts are based on the active protein.

The identity of nucleic acid or amino acid sequences is determined by a sequence comparison. This sequence comparison is based on the established BLAST algorithm, which is commonly used in the prior art (see for example Altschul, S. F., Gish, W., Miller, W., Myers, E. W. & Lipman, D. J.). (1990) “Basic local alignment search tool.” J. Mol. Biol. 215:403-410, and Altschul, Stephan F., Thomas L. Madden, Alejandro A. Schaffer, Jinghui Zhang, Hheng Zhang, Webb Miller, and David J. Lipman (1997): “Gapped BLAST and PSI-BLAST: a new generation of protein database search programs”; Nucleic Acids Res., 25, pg. 3389-3402) and occurs in principle when similar sequences of nucleotides or amino acids are assigned to each other in the nucleic acid or amino acid sequences. A tabular association of the positions concerned is referred to as alignment. Another algorithm available in the prior art is the FASTA algorithm. Sequence comparisons (alignments), in particular multiple sequence comparisons, are created using computer programs. The Clustal series, for example, is frequently used (cf. Chenna et al. (2003): Multiple sequence alignment with the Clustal series of programs. Nucleic Acid Research 31, 3497-3500), as is T-Coffee (cf. for example Notredame et al. (2000): T-Coffee: A novel method for multiple sequence alignments. J. Mol. Biol. 302, 205-217) or programs based on these programs or algorithms. There are other possible sequence comparisons (alignments) using the computer program Vector NTI® Suite 10.3 (Invitrogen Corporation, 1600 Faraday Avenue, Carlsbad, Calif., USA) and predetermined standard parameters, the program's AlignX module for sequence comparisons being based on ClustalW.

Such a comparison also allows conclusions to be drawn regarding the similarity of the compared sequences. It is usually given in percent identity, i.e. the proportion of identical nucleotides or amino acid radicals in said sequences or in an alignment of corresponding positions. The broader concept of homology takes conserved amino acid exchanges into account in the case of amino acid sequences, i.e. amino acids having similar chemical activity, since they usually perform similar chemical activities within the protein. Therefore, the similarity between the compared sequences can also be expressed in percent homology or percent similarity. Identity and/or homology information can be provided regarding whole polypeptides or genes or only regarding individual regions. Homologous or identical regions of different nucleic acid or amino acid sequences are therefore defined by matches in the sequences. Such regions often have identical functions. They can be small and comprise only a few nucleotides or amino acids. Often, such small regions perform essential functions for the overall activity of the protein. It may therefore be expedient to relate sequence matches only to individual or optionally small regions. Unless stated otherwise, however, identity or homology information in the present application relates to the entire length of the particular nucleic acid or amino acid sequence indicated.

In a further embodiment, the detergent or cleanser as described herein contains at least one enzyme (A) with an amino acid sequence which is at least 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 98.8%, 99.0%, 99.2%, 99.4% or 99.6% homologous to the amino acid sequence indicated in SEQ ID NO:1, SEQ ID NO:2 or SEQ ID NO:3 over its entire length.

In a further embodiment, the detergent or cleanser is characterized in that the catalytic performance of the at least one enzyme (A) is not significantly reduced, i.e. has at least 70%, 75%, 80%, 85%, 90%, 95% of the reference performance, compared to that of an enzyme (A) which comprises an amino acid sequence which is as shown in SEQ ID NO: 1, SEQ ID NO: 2 or SEQ ID NO: 3.

In various embodiments, the enzyme (A) is the enzyme NQO1 having the amino acid sequence indicated in SEQ ID NO: 1 or a variant or homolog thereof having the sequence identities or homologies set forth herein. The enzyme NQO1 (NAD(P)H: quinone oxidoreductase 1) is a cytosolic flavoenzyme, also known as DT diaphorase (EC 1.6.99.2). The enzyme is described in U.S. Pat. No. 9,890,397 B1, for example. In various other embodiments, the enzyme (A) is the enzyme NAD(P)H quinone oxidoreductase from Pseudomonas aeruginosa having the amino acid sequence given in SEQ ID NO: 2. In yet another embodiment, the enzyme (A) is the enzyme quinone reductase from E. coli K12 having the amino acid sequence given in SEQ ID NO: 3.

Further enzymes (A) used in the detergents or cleansers may have further amino acid changes, in particular amino acid substitutions, insertions or deletions, in comparison with the enzyme described in SEQ ID NO: 1, SEQ ID NO: 2 or SEQ ID NO: 3. Such enzymes (A) are, for example, developed by targeted genetic alteration, i.e. by mutagenesis methods, and optimized for specific applications or with regard to specific properties (for example with regard to their catalytic activity, stability, etc.).

In various embodiments, the detergent or cleanser contains an enzyme (A) obtainable by single or multiple conservative amino acid substitution starting from the starting molecule according to SEQ ID NO: 1, SEQ ID NO: 2 or SEQ ID NO: 3, as described above. The term “conservative amino acid substitution” means the exchange (substitution) of one amino acid radical for another amino acid radical, with this exchange not resulting in a change to the polarity or charge at the position of the exchanged amino acid, e.g. the exchange of a nonpolar amino acid radical for another nonpolar amino acid radical. Conservative amino acid substitutions include, for example: G=A=S, I=V=L=M, D=E, N=Q, K=R, Y=F, S=T, G=A=I=V=L=M=Y=F=W=P=S=T. The enzymes (A) so modified may be homologous to the starting enzyme having SEQ ID NO: 1, SEQ ID NO: 2 or SEQ ID NO: 3 as defined above.

In various further embodiments, the detergent or cleanser is characterized in that the at least one enzyme (A) can be obtained from an enzyme (A) as defined above as the starting molecule by fragmentation, deletion, insertion or substitution mutagenesis and comprises an amino acid sequence which has a length of at least 150, 155, 160, 165, 170, 175, 180, 185, 186, 187, 190, 200, 210, 215, 220, 225, 230, 231, 232, 233, 240, 245, 250, 260, 261, 262, 263, 264, 265, 266, 267, 268, 269, 270, 271, 272, 273, or 274 amino acids joined together and matches the parent molecule.

For instance, it is possible to delete individual amino acids at the termini or in the loops of the enzyme without losing or reducing catalytic activity in the process. Furthermore, such fragmentation, deletion, insertion or substitution mutagenesis can also reduce the allergenicity of the enzymes concerned, for example, and thus improve their overall applicability. Advantageously, the enzymes also retain their catalytic activity even after mutagenesis, i.e. their catalytic activity corresponds at least to that of the starting enzyme, i.e. in a non-limiting embodiment the catalytic activity is at least 80%, such as at least 90%, of the activity of the starting enzyme. Other substitutions can also exhibit advantageous effects. Both single and multiple contiguous amino acids can be exchanged for other amino acids.

In various embodiments, the detergent or cleanser may comprise at least one enzyme (A) which, in addition to the sequence N- or C-terminal given in SEQ ID NO: 1, SEQ ID NO: 2 or SEQ ID NO: 3, has one or more further amino acids, respectively. For example, in certain embodiments, such N-terminal peptides may be a single methionine radical.

However, the enzyme (A) may be a mature enzyme (A), i.e. the catalytically active molecule without signal and/or propeptide(s).

In various embodiments, the enzyme (A) is present in the detergents or cleansers in the form of an enzyme-containing composition A.

In various embodiments, such an enzyme-containing composition A comprises at least one organic solvent, such as alcohols, alternatively polyvalent alcohols at standard conditions (20° C., 1013 mbar), in particular glycerol, 1,2-propanediol and sorbitol, and mixtures thereof. When included, the amount is from 0.1 to 99.9 wt.-%, alternatively from 10 to 90 wt.-%, based on the total weight of the enzyme-containing composition.

In various embodiments, the enzyme (A) is a free enzyme. This means that the enzyme (A) can act directly with all the components of a detergent or cleanser and, since the enzyme-containing composition A is a liquid, that the enzyme (A) is in direct contact with the solvent of the detergent or cleanser (e.g. water).

In other embodiments, a detergent or cleanser may contain at least one enzyme (A) that forms an interaction complex with other molecules or that has a “shell.” In this case, an individual or plurality of enzyme (A) molecules may be separated from the other constituents of the detergent or cleanser by a surrounding structure. Such a separating structure may arise from, but is not limited to, vesicles such as a micelle or a liposome, or micro-/nanocapsules, typically with a polymer shell.

An enzyme-containing composition A as described above contains the at least one enzyme (A) in an amount of active protein of 0.1 to 50 wt.-%, alternatively 0.1 to 20 wt.-%, based on the total weight of the composition.

In various embodiments, the detergents or cleansers contain enzyme (A) overall in an amount of 0.00001 to 10 wt.-%, such as in an amount of 0.0002 to 0.8 wt.-%, based on the total weight of the detergent or cleanser, respectively. The above amounts are based on the respective active protein.

The protein concentration can be determined using known methods, for example the BCA method (bicinchoninic acid; 2,2′-bichinolyl-4,4′-dicarboxylic acid) or the Biuret method (A. G. Gornall, C. S. Bardawill and M. M. David, J. Biol. Chem., 177 (1948), pp. 751-766). The determination of the active protein concentration can be performed by titrating the active centers using a suitable irreversible inhibitor and determining the residual activity (see M. Bender et al., J. Am. Chem. Soc. 88, 24 (1966), pp. 5890-5913).

In various embodiments, the enzyme-containing composition A containing the at least one enzyme (A) further contains at least one surfactant, such as an alkoxylated alcohol, i.e. a fatty alcohol ethoxylate, in an amount of 0.01 to 10, alternatively 0.01 to 5 wt.-%, based on the total weight of the composition.

The composition A may further contain at least one enzyme stabilizer and/or enzyme inhibitor, such as in an amount of 0.001 to 50 wt.-%, alternatively 0.01 to 10 wt.-%, based on the total weight of the enzyme-containing composition. Suitable stabilizers/inhibitors are all compounds known in the art for this purpose. In various embodiments, the composition A contains in particular a substance (A-I) which acts as an inhibitor, in particular as a competitive inhibitor, for the enzyme (A). Suitable substances may be selected depending on the enzyme (A) and are exemplified herein.

In various non-limiting embodiments, composition A contains no further enzymes in addition to the at least one enzyme (A).

In a non-limiting embodiment, the composition A contains the at least one enzyme (A) and optionally further constituents in amounts which are typically used in enzyme formulations as such, but not in enzyme-containing detergents and cleansers. For example, the active protein content can therefore be in the range from 0.1 to 20 wt.-%, such as in the range from 1 to 15 wt.-%. The amount of stabilizer is then adjusted according to the amount of enzyme and may also be in the range of 0.01 to 15 wt.-%.

In various embodiments, the enzyme-containing composition A may contain water as a solvent, but also low-water to anhydrous compositions are possible. In the latter, in particular the abovementioned organic solvents are then used.

“Low-water” refers to water contents of up to 20 wt.-%, such as up to 15 wt.-%, more alternatively up to 10 wt.-%, and “anhydrous” refers to water contents of up to 5 wt.-%, in particular compositions in which water is not intentionally added, but is at most entrained with other ingredients. The water content can be determined by Karl Fischer titration. When the detergents or cleansers are partially water-poor to anhydrous, in various embodiments the indicated pH refers to a 1% solution of each composition in distilled water at 25° C.

In various embodiments, the pH of the enzyme-containing composition is in the range of 5 to 9.

In non-limiting embodiments, the enzyme-containing composition A is a liquid or gel.

According to non-limiting embodiments, the at least one enzyme (A) is used in the detergents or cleansers described herein to catalyze the hydrogenation of substrates (C) under suitable conditions, i.e. in the presence of oxygen, for example atmospheric oxygen, in particular enzyme (A)-activated substrates, whereby, as described above, hydrogen peroxide can be formed in an aqueous environment, for example in a wash liquor.

“Substrates” as used herein with respect to the described enzymes refers to compounds that can be catalytically reacted by said enzymes. The conversion rate may be sufficiently high to effect a conversion sufficient. In various embodiments, the conversion rate corresponds to at least 10%, such as at least 25% or more, of the rate of conversion of the enzyme for its natural substrate.

Suitable substrates as defined above include, but are not limited to, quinones in general, and especially β-lapachone (2,2-dimethyl-3,4-dihydro-2H-benzo[h]chromene-5,6-dione), streptonigrin, deoxynyboquinone, isobutyldeoxynyboquinone, mitomycin C, KP372-1 (6H-indeno[1,2-ε]tetrazolo[1,5-b][1,2,4]triazine-6-one and 10H-indeno[2,1-ε]tetrazolo[1,5-b][1,2,4]triazine-10-one (1:1)), phenothiazinium compounds, 2,5-diaziridinyl-3(hydroxymethyl)-6-methyl-1,4-benzoquinone (RH1), apaziquinone (EO9), indolequinones, pronoqodine A, quinolinequinones, binaphthylquinones, anthraquinone, plastoquinone, pyrroloquinoline quinone, carbazilquinone, chloranil, dibromothymoquinone, plastoquinone, ubiquinone, indolequinones, porfiromycin, Pyrroliminoquinones, atovaquone, vitamin K, vitamin K1, vitamin K2 and vitamin K3. Furthermore, it is possible that such substrates also come from dirt or stains on the linen or dishes to be washed or cleaned, which are to be bleached and removed in the washing or cleaning process. In various embodiments, the substrate (C) may therefore be included in the composition or, alternatively, may not be present and then originate from the stains to be bleached. In both embodiments, both of these are possible. However, the detergents or cleansers may include at least one suitable substrate (C).

In various such embodiments, the at least one substrate (C) is selected from quinones, especially β-lapachone, streptonigrin, deoxynyboquinone, isobutyldeoxynyboquinone, mitomycin C, KP372-1, phenothiazinium compounds, 2,5-diaziridinyl-3-(hydroxymethyl)-6-methyl-1,4-benzoquinone (RH1), apaziquinone (EO9), indolequinones, pronoqodine A, quinolinequinones and binaphthylquinones.

In non-limiting embodiments, the at least one substrate (C) is β-lapachone.

In various embodiments, the at least one substrate (C) as defined herein is present in the detergent or cleanser in an amount of from 0.2 to 25 wt.-%, such as in an amount of from 1 to 6 wt.-%, based on the total weight of the detergent or cleanser.

For the reaction (hydrogenation) of the substrate (C), the enzyme (A) requires as cofactor NADPH (nicotinamide adenine dinucleotide phosphate) or NADH (nicotinamide adenine dinucleotide) as explained above. These are summarized herein by the term NAD(P)H. In various embodiments, the composition contains this component (B) in an amount of 0.001 to 2 wt.-%, such as in an amount of 0.1 to 0.5 wt.-%, based on the total weight of the detergent or cleanser, respectively.

So that the reaction to be catalyzed by the enzyme (A) cannot already take place in the detergent or cleanser but only in the course of the washing or cleaning process, either at least one substance (A-I) functioning as enzyme inhibitor for the enzyme (A) must be present in the detergent or cleanser, or the component (A) must be spatially separated from the components (B) and (C) in the detergent or cleanser as defined above. In various embodiments, in spite of spatial separation of component (A) from components (B) and (C), at least one substance (A-I) is additionally present in the detergent or cleanser. In general, the substance (A-I), if present, is formulated together with the enzyme (A), i.e. it is contained in an enzyme-containing composition A, for example.

In various embodiments, component (A-I) is a competitive inhibitor of the enzyme (A). In various embodiments, component (A-I) is a substance from the class of 4-hydroxycoumarins. Such compounds are described in, for example, Ferry et al. 2010 (“Old and new inhibitors of quinone reductase 2,” Chemico-Biological Interaction, Volume 186) and comprise but are not limited to dicoumarol, melatonin, resveratrol and chrysoeriol.

In various embodiments, the component (A-I), i.e., the at least one substance (A-I), is contained in an amount of 0.00001 to 10 wt.-%, such as in an amount of 0.0002 to 0.8 wt.-%, in each case based on the total weight of the detergent or cleanser.

In various embodiments, the detergent or cleanser is in the form of a multi-chamber system, for example a multi-chambered pouch, and the component (A) is located in a different chamber of the multi-chamber system than the components (B) and (C). A multi-chamber system, such as a pouch, comprises at least two, i.e. two or more chambers, for example two, three or four chambers. In exemplary embodiments, component (A) is in the form of an enzyme-containing composition A, as defined herein, while components (B) and (C) are contained in a composition B, wherein composition A and composition B are contained in different chambers of the composition multi-chamber system.

According to non-limiting embodiments, compositions containing component (A) and compositions containing components (B) and (C) may be liquid.

From an economic point of view, it is advantageous if the cofactor which as explained above is oxidized, i.e. consumed, at the end of the reaction catalyzed by the enzyme (A), as explained above. In various embodiments, the detergent or cleanser therefore further comprises at least one enzyme (D) which is suitable for the regeneration of the cofactor (B) and at least one substrate (E) for the corresponding enzyme (D).

In various embodiments, the at least one enzyme (D) is an enzyme that can regenerate NADH or NADPH. A suitable enzyme is, but is not limited to, a glucose dehydrogenase which converts D-glucose to D-glucono-1,5-lactone while regenerating NADH or NADPH (NAD(P)H), i.e. reduction of NAD(P)⁺. Accordingly, according to these embodiments, the at least one substrate (E) is, for example, D-glucose.

In various other embodiments, the at least one enzyme (D) is a glucose-6-phosphate dehydrogenase which converts glucose-6-phosphate to 6-phosphogluconolactone while regenerating NADPH. Accordingly, according to these embodiments, the at least one substrate (E) is, for example, glucose-6-phosphate.

In still other embodiments, the at least one enzyme (D) is an alcohol dehydrogenase which converts primary and secondary alcohols to the corresponding aldehydes or ketones, respectively, while regenerating NAD(P)H. Accordingly, according to these embodiments, the at least one substrate (E) is, for example, a primary or secondary alcohol, for example ethanol.

Alternatively, other NAD(P)H-regenerating enzymes (D) and corresponding substrates (E) can be used. Corresponding systems are generally described in “Regeneration of Nicotinamide Coenzymes: Principles and Applications for the Synthesis of Chiral Compounds,” Weckbecker et al., 2010.

In various embodiments, component (D) is present in an amount of from 0.00001 to 10 wt.-%, such as in an amount of from 0.0002 to 0.8 wt.-%, based in each case on the total weight of the composition containing the detergents or cleansers.

In further embodiments, the component (E) is present in an amount of 0.2 to 25 wt.-%, such as in an amount of 1 to 10 wt.-%, each based on the total weight of the composition containing the detergents or cleansers.

In various embodiments, the component (D) and the component (E) are spatially separated from each other in the detergent or cleanser. For example, in the detergents or cleansers, component (D) may be contained in composition B comprising components (B) and (C) while component (E) is present in composition A comprising the enzyme (A). Alternatively, the detergents or cleansers may comprise other compositions in addition to compositions A and B. Accordingly, it is possible, by way of example, to formulate the component (D) in an additional, enzyme-containing composition C, while the component (E) is in turn formulated either in the enzyme-containing composition A, the composition B or else a further composition D.

Component (D) can thus likewise be present in the form of an enzyme-containing composition C in the detergents or cleansers, as already described for component (A). Unlike the component (A), however, in various embodiments the component (D) may be formulated in the form of an enzyme-containing composition C which in addition to the at least one enzyme (D) comprises one or more further enzymes commonly used in detergents or cleansers. Proteases, amylases, lipases, cellulases, mannanases, hem icellulases, perhydrolases, further oxidoreductases and combinations of several of these are mentioned by way of example and without limitation.

As already explained above with respect to an enzyme-containing composition A containing component (A), component (D) can also be further enzymes present in the detergent or cleanser, each present in the detergent or cleanser independently of one another in free form or in a shell.

In various embodiments, the detergent or cleanser is in the form of a multi-chamber system, such as a multi-chambered pouch, and component (D) and component (E) are present in different chambers of the multi-chamber system.

The detergents or cleansers described herein may be of a liquid nature and may, in particular, be present as homogeneous solutions or suspensions. In various embodiments comprising a composition A, a composition B and optionally further compositions C and/or D, it can alternatively be that only the corresponding compositions A, B, C and/or D are in liquid form, while optionally further compositions may be in solid form. “Solid” in this context means that the composition is present under standard conditions as a solid, in particular as a powder or granulate or compacted material.

In a further non-limiting embodiment, the detergent or cleanser is present in a pre-portioned form. The detergent or cleanser has several spatially separate compositions, which makes it possible on the one hand to separate incompatible ingredients from each other, as described above, and on the other hand to offer compositions in combination which are used at different times.

Depending on the desired application, the compositions, in various embodiments, further comprise at least one other constituent, such as at least two other constituents selected from the group consisting of builders, surfactants, polymers, water-miscible solvents, pH regulators, other enzymes, other enzyme stabilizers/inhibitors, bleaches, bleach catalysts, bleach activators, foam regulators, dyes, perfumes and perfume carriers. According to the above specifications, such further constituents may be present in detergents or cleansers in the respective compositions A, B and optionally C and/or D, or in additional compositions containing none of the above-defined components (A), (B), (C), (D), (E) and (A-I).

Accordingly, the detergents or cleansers may contain at least one builder. The builders include, in particular, carbonates, citrates, phosphonates, organic structural materials, and silicates. The proportion by weight of all builders in the total weight of detergents or cleansers is, for example, 5 to 35 wt.-%, such as from 8 to 25 wt.-%.

Some examples of organic builders that are suitable are the polycarboxylic acids (polycarboxylates) that can be used in the form of their sodium salts, with polycarboxylic acids being understood as being those carboxylic acids that carry more than one, in particular two to eight, acid functions, such as two to six, in particular two, three, four, or five acid functions in the entire molecule. As polycarboxylic acids, dicarboxylic acids, tricarboxylic acids, tetracarboxylic acids, and pentacarboxylic acids, in particular di-, tri-, and tetracarboxylic acids, may be used. The polycarboxylic acids can also carry additional functional groups such as hydroxyl or amino groups, for example. For example, these include citric acid, adipic acid, succinic acid, glutaric acid, malic acid, tartaric acid, maleic acid, fumaric acid, sugar acids (i.e. aldaric acids, for example galactaric acid and glucaric acid), aminocarboxylic acids, in particular aminodicarboxylic acids, aminotricarboxylic acids, aminotetracarboxylic acids such as, for example, nitrilotriacetic acid (NTA), methylglycinediacetic acid (MGDA), glutamic-N,N-diacetic acid (also called N,N-bis(carboxymethyl)-L-glutamic acid or GLDA), asparaginic acid diacetate (ASDA), hydroxyethyliminodiacetate (HEIDA), iminodisuccinate (IDS) and ethylenediamine disuccinate (EDDS), and derivatives thereof and mixtures thereof. Non-limiting salts are the salts of the polycarboxylic acids such as citric acid, adipic acid, succinic acid, glutaric acid, tartaric acid, MGDA, and mixtures thereof.

Other substances that are suitable as organic builders are polymeric polycarboxylates (organic polymers with a plurality of (in particular greater than ten) carboxylate functions in the macromolecule), polyaspartates, polyacetals, and dextrins.

Besides their building effect, the free acids also typically have the quality of an acidifying component, and can thus be used for pH adjustment. Particularly noteworthy here are citric acid, succinic acid, glutaric acid, adipic acid, gluconic acid, and any mixtures thereof.

Detergents or cleaning detergents or cleansers can also contain, as a builder, crystalline layered silicates of general formula NaMSiₓO₂ₓ₊₁, y H₂O, where M represents sodium or hydrogen, x is a number from 1.9 to 22, such as from 1.9 to 4, with 2, 3, or 4 being particularly non-limiting values for x, and y represents a number from 0 to 33, such as from 0 to 20. It is also possible to use amorphous sodium silicates with a Na₂O:SiO₂ modulus of 1:2 to 1:3.3, such as of 1:2 to 1:2.8 and in particular of 1:2 to 1:2.6, which may be delayed in dissolution and have secondary washing properties. In certain detergents or cleansers, in particular dishwashing detergents, i.e. automatic dishwashing detergents, the silicate content, based on the total weight of the detergent or cleanser, is limited to amounts below 10 wt.-%, such as below 5 wt.-%, and in particular below 2 wt.-%. In a non-limiting embodiment, the detergents or cleansers are free of silicates, “free” in this context meaning that the amount is limited to less than 0.1 wt.-%.

In various embodiments, compositions comprise as one of the essential builders thereof one or more salts of citric acid, i.e. citrates.

A carbonate(s) and/or bicarbonate(s) may also be used, such as alkali metal carbonate(s), i.e. sodium carbonate (soda).

In addition to the aforementioned builders, the detergents or cleansers can also contain alkali metal hydroxides as alkali sources. These alkali carriers may be used in the detergents or cleansers only in small quantities, such as in quantities below 10 wt.-%, i.e. below 6 wt.-%, alternatively below 5 wt.-%, alternatively between 0.1 and 5 wt.%, and in particular between 0.5 and 5 wt.-%, in each case based on the total weight of the cleaning detergent or cleanser. However, the detergents or cleansers may contain only small amounts of NaOH, i.e. they may be free of NaOH. In various embodiments, instead of NaOH, the detergent or cleanser comprises potassium hydroxide (KOH) as the alkali source, such as in the amounts indicated above, in particular up to 3.5 wt.-%. In particular, the alkali metal hydroxides, especially KOH, are used in amounts such that the desired pH values of the compositions are achieved.

Suitable surfactants are all known nonionic, anionic, cationic, zwitterionic and amphoteric surfactants, at least nonionic and/or anionic surfactants being used in various embodiments.

All non-ionic surfactants that are known to a person skilled in the art can be used as non-ionic surfactants. Surfactants that are used come from the group of the alkoxylated non-ionic surfactants, in particular the ethoxylated primary alcohols and mixtures of these surfactants with structurally complex surfactants such as polyoxypropylene/polyoxyethylene/polyoxypropylene ((PO/EO/PO) surfactants).

The detergents or cleansers, in particular dishwashing detergents, may further comprise at least one sulfopolymer. The proportion by weight of the sulfopolymer in the total weight of the composition containing it, such as B or C, is from 0.1 to 20 wt.-%, such as from 0.5 to 15 wt.-%, that is from 1.0 to 10 wt.-%, alternatively 2 to 8 wt.-%, alternatively from 3 to 6 wt.-%. In a non-limiting embodiment, compositions may contain up to 6 wt.-% of sulfopolymer. The sulfopolymer is usually used in the form of an aqueous solution, the aqueous solutions typically containing 20 to 70 wt.-%, in particular 30 to 50 wt.-%, such as about 35 to 40 wt.-% sulfopolymers.

The sulfopolymer used is a copolymeric polysulfonate, such as a hydrophobically modified copolymeric polysulfonate.

Non-limiting anionic surfactants are fatty alcohol sulfates, fatty alcohol ether sulfates, dialkyl ether sulfates, monoglyceride sulfates, alkylbenzene sulfonates, olefin sulfonates, alkane sulfonates, ether sulfonates, n-alkyl ether sulfonates, ester sulfonates and lignosulfonates. Fatty acid cyanamides, sulfosuccinates (sulfosuccinic acid esters), in particular sulfosuccinic acid mono- and di-C₈-C₁₈-alkyl esters, sulfosuccinamates, sulfosuccinam ides, fatty acid isethionates, acylaminoalkansulfonates (fatty acid taurides), fatty acid sarcosinates, ether carboxylic acids and alkyl(ether)phosphates, and α-sulfo fatty acid salts, acylglutamates, monoglyceride disulfates and alkyl ethers of glycerol disulfate can also be used.

The anionic surfactants may be used as sodium salts, but can also be contained as other alkali or alkaline-earth metal salts, for example potassium or magnesium salts, and in the form of ammonium salts or mono-, di-, tri- or tetraalkylammonium salts, and in the case of the sulfonates, also in the form of their corresponding acids, e.g. dodecylbenzenesulfonic acid.

Suitable amphoteric surfactants are, for example, betaines of formula (Rⁱⁱⁱ)(R^{iv})(R^{v})N⁺CH₂COO⁻, in which Rⁱⁱⁱ denotes an alkyl functional group, which is optionally interrupted by heteroatoms or heteroatom groups, having 8 to 25, such as 10 to 21, carbon atoms, and R^{iv} and R^{v} denote identical or different alkyl functional groups having 1 to 3 carbon atoms, in particular C₁₀-C₁₈ alkyl dimethyl carboxymethyl betaine and C₁₁-C₁₇ alkyl amido propyl dimethyl carboxymethyl betaine.

As zwitterionic surfactants, for example, amine oxides can be used.

Suitable cationic surfactants are, inter alia, the quaternary ammonium compounds of formula (R^{vi})(R^{vii})(R^{viii})(R^{ix})N⁺X⁻, in which R^{vi} to R^{ix} denote four identical or different, and in particular two long-chain and two short-chain, alkyl functional groups, and X⁻ denotes an anion, in particular a halide ion, for example didecyl dimethyl ammonium chloride, alkyl benzyl didecyl ammonium chloride and the mixtures thereof. Further suitable cationic surfactants are the quaternary surface-active compounds, in particular having a sulfonium, phosphonium, iodonium or arsonium group, which are also known as antimicrobial detergents or cleansers. Through the use of quaternary surface-active compounds with antimicrobial action, the detergent or cleanser can be designed with an antimicrobial effect or an antimicrobial effect thereof, which may already be present due to other ingredients, can be improved.

In various embodiments, the detergent or cleanser can contain, in addition to the optionally contained enzyme inhibitor (A-I), further enzyme stabilizers and inhibitors. The stabilizers and inhibitors mentioned below can be used in particular if the detergents or cleansers contain proteases and may then be contained in the same composition which also contains the proteases.

Other established enzyme stabilizers are amino alcohols such as mono-, di-, triethanol- and -propanolamine and mixtures thereof, aliphatic carboxylic acids up to C₁₂, such as succinic acid, other dicarboxylic acids or salts of said acids. End-capped fatty acid amide alkoxylates are also established for this purpose.

Also suitable as enzyme stabilizers are, for example, water-soluble calcium salts, such as calcium chloride (CaCl₂), calcium lactate or calcium acetate, and other salts of calcium with alpha-hydroxycarboxylic acids or alpha-amino acids. Also suitable are organic (metal) salts such as formates and acetates.

Non-limiting boronic acid compounds are phenylboronic acid derivatives, in particular the phenylboronic acid derivative 4-formyl-phenylboronic acid (4-FPBA). Further non-limiting phenylboronic acid derivatives may also have further chemical modifications on the phenyl ring, in particular they may contain one or more methyl, amino, nitro, chloro, fluoro, bromo, hydroxyl, formyl, ethyl, acetyl, t-butyl, anisyl, benzyl, trifluoroacetyl, N-hydroxysuccinimide, t-butyloxycarbonyl, benzoyl, 4-methylbenzyl, thioanizyl, thiocresyl, benzyloxymethyl, 4-nitrophenyl, benzyloxycarbonyl, 2-nitrobenzoyl, 2-nitrophenylsulphenyl, 4-toluenesulphonyl, pentafluorophenyl, diphenylmethyl, 2-chlorobenzyloxycarbonyl, 2,4,5-trichlorophenyl, 2-bromobenzyloxycarbonyl, 9-fluorenylmethyloxycarbonyl, triphenylmethyl, 2,2,5,7,8-pentamethylchroman-6-sulphonyl radicals or groups or combinations thereof. Generally, the term “boronic acids” as used herein encompasses all compounds of the formula R—B(OH)₂ in which R is an organic radical, and salts and esters thereof in which one or both hydrogens are replaced by cations or an organic radical.

In various embodiments, the compounds of the following general structural formula can furthermore be used as enzyme stabilizers:

ZA-(A)ₙ-NH—CH(R)—Y (I)

where A is an amino acid radical (non-limiting amino acid radicals A are selected from Ala, Gly, Val, Ile, Leu, Phe, Lys); Y is —C(O)—X or CHOH—SO₃B, B is hydrogen or a suitable cation, especially (alkali) metal cation, X is hydrogen or CF₃; Z is an N-capping moiety selected from phosphoramidate [(R′O)₂(O)P—], sulfenamide [(SR′)₂—], sulfone amide [(R′(O)₂S—], sulfonic acid [SO₃H], phosphinamide [(R′)₂(O)P—], sulfamoyl derivatives [R′O(O)₂S—], thiourea [(R′)₂N(O)C—], thiocarbamate [R′O(S)C—], phosphonate [R′—P(O)OH], amidophosphate [R′O(OH)(O)P—], carbamate (R′O(O)C—) and urea (R′NH(O)C—) wherein each R′ is independently selected from C1-C6 straight or branched unsubstituted alkyl, phenyl, C7-C9 alkylaryl and cycloalkyl radicals wherein the cycloalkyl ring may be a C4-C8 cycloalkyl ring and may contain one or more heteroatoms selected from O, N, and S; R is selected from straight or branched C1-C6 unsubstituted alkyl, phenyl, and C7-C9 alkylaryl radicals, in particular —CH₂-phenyl or —CH₂-(4-hydroxyphenyl); and n is 0, 1 or 2, from 0 or 1, wherein when n is not 0, and the amino acids are linked via a peptide bond.

Non-limiting radicals R are selected from methyl, isopropyl, sec-butyl, isobutyl, —C₆H₅, —CH₂—C₆H₅, —CH₂—C₆H₄OH (in particular CH₂-(4-hydroxyphenyl), and —CH₂—CH₂—C₆H₅ such that the —NH—CH(R)—Y portion of the compound of formula (I) is derived from the amino acids Ala, Val, Ile, Leu, Tyr, PGly (phenylglycine), Phe and HPhe (Homophenylalanine), in that the carboxyl group is converted to an aldehyde or trifluoromethylketone group or an aldehyde-bisulfite adduct. Therefore, although such radicals are not amino acids (although they may be synthesized from an amino acid precursor), in the case of the exemplified enzyme stabilizers, for convenience the aldehyde portion of the inhibitors derived from the corresponding amino acids will be identified by the suffix “H” after the analogous amino acid (e.g. “-AlaH” represents the radical “—NHCH(CH₃)C(O)H”). Trifluoromethyl ketones are identified in the same way by the addition “CF₃” after the analogous amino acid (e.g., “-AlaCF₃” is the radical “—NHCH(CH₃)C(O)CF₃”). Finally, the bisulfite adducts of aldehydes are designated by the term “SO₃H” or “SO₃Na” after the analogous amino acid (e.g., “-TyrSO₃H” represents the radical “—NHCH(CH₂C₆H₄OH)CHOH—SO₃H”).

Such aldehydes can be prepared from the corresponding amino acids, with the C-terminal carboxyl group of the amino acid being converted to an aldehyde group. Such aldehydes can be prepared by known methods, as described, for example, in U.S. Pat. No. 5,015,627, EP 0 185 930, EP 0 583 534 and DE 3200812.

The trifluoromethyl ketones can also be prepared from the corresponding amino acids by converting the C-terminal carboxyl group into a trifluoromethyl ketone group. Such trifluoromethyl ketones can be prepared by known methods, for example as described in EP 0 583 535.

The N-terminal end of the enzyme stabilizers is protected by a protecting group capping the N-terminus, the group being selected from carbamates, ureas, sulfonamides, phosphonamides, thioureas, sulfenam ides, sulfonic acids, phosphinam ides, thiocarbamates, am idophosphates and phosphonamides. However, in a non-limiting embodiment, the N-terminal end is replaced by a methyl, ethyl or benzyl carbamate group [CH₃O—(O)C—; CH₃CH₂O—(O)C—; or C₆H₅CH₂O—(O)C—], a methyl, ethyl or benzyl urea group [CH₃NH—(O)C—; CH₃CH₂NH—(O)C—; or C₆H₅CH₂NH—(O)C—], a methyl, ethyl or benzylsulfonamide group [CH₃SO₂—; CH₃CH₂SO₂—; or C₆H₅CH₂SO₂—], or a methyl, ethyl or benzylamidophosphate group [CH₃O(OH)(O)P—; CH₃CH₂O(OH)(O)P—; or C₆H₅CH₂O(OH)(O)P—].

The synthesis of the N-capping groups can be found, for example, in the following documents: Protective Groups in Organic Chemistry, Greene, T., Wuts, P., John Wiley & Sons, New York, 1991, pp 309-405; March, J, Advanced Organic Chemistry, Wiley Interscience, 1985, pp. 445, 469, Carey, F. Sundberg, R., Advanced Organic Chemistry, Part B, Plenum Press, New York, 1990, pp. 686-89; Atherton, E., Sheppard, R., Solid Phase Peptide Synthesis, Pierce Chemical, 1989, pp. 3-4; Grant, G., Synthetic Peptides, W. H. Freeman & Co. 1992, pp. 77-103; Stewart, J., Young, J., Solid Phase Peptide Synthesis, 2nd Edition, IRL Press, 1984, pp. 3, 5, 11, 14-18, 28-29. Bodansky, M., Principles of Peptide Synthesis, Springer-Verlag, 1988, pp. 62, 203, 59-69; Bodansky, M., Peptide Chemistry, Springer-Verlag, 1988, pp. 74-81, Bodansky, M., Bodansky, A., The Practice of Peptide Synthesis, Springer-Verlag, 1984, pp. 9-32.

Exemplary enzyme stabilizers that can be used include, but are not limited to: CH₃O—(O)C-Leu-LeuH; CH₃O—(O)C-Ala-LeuH; CH₃CH₂O—(O)C-Ala-LeuH; C₆H₅CH₂O—(O)C-Ala-LeuH; CH₃O—(O)C-Ala-LeuCF₃; CH₃CH₂O—(O)C-Ala-LeuCF₃; C₆H₅CH₂O—(O)C-Ala-LeuCF₃; CH₃O—(O)C-Ala-IleH; CH₃CH₂O—(O)C-Ala-IleH; C₆H₅CH₂O—(O)C-Ala-IleH; CH₃O—(O)C-Ala-IleCF₃; CH₃CH₂O—(O)C-Ala-IleCF₃; C₆H₅CH₂O—(O)C-Ala-IleCF₃; CH₃O—(O)C-Gly-LeuH; CH₃CH₂O—(O)C-Gly-LeuH; C₆H₅CH₂O—(O)C-Gly-LeuH; CH₃O—(O)C-Gly-LeuCF₃; CH₃CH₂O—(O)C-Gly-LeuCF₃; C₆H₅CH₂O—(O)C-Gly-LeuCF₃; CH₃O—(O)C-Gly-IleH; CH₃CH₂O—(O)C-Gly-IleH; C₆H₅CH₂O—(O)C-Gly-IleH; CH₃O—(O)C-Gly-IleCF₃; CH₃CH₂O—(O)C-Gly-IleCF₃; C₆H₅CH₂O—(O)C-Gly-IleCF₃; CH₃NH—(O)C-Ala-LeuH; CH₃CH₂NH—(O)C-Ala-LeuH; C₆H₅CH₂NH—(O)C-Ala-LeuH; CH₃NH—(O)C-Ala-LeuCF₃; CH₃CH₂NH—(O)C-Ala-LeuCF₃; C₆H₅CH₂NH—(O)C-Ala-LeuCF₃; CH₃NH—(O)C-Ala-IleH; CH₃CH₂NH—(O)C-Ala-IleH; C₆H₅CH₂NH—(O)C-Ala-IleH; CH₃NH—(O)C-Ala-IleCF₃; CH₃CH₂NH—(O)C-Ala-IleCF₃; C₆H₅CH₂NH—(O)C-Ala-IleCF₃; CH₃NH—(O)C-Gly-LeuH; CH₃CH₂NH—(O)C-Gly-LeuH; C₆H₅CH₂NH—(O)C-Gly-LeuH; CH₃NH—(O)C-Gly-LeuCF₃; CH₃CH₂NH—(O)C-Gly-LeuCF₃; C₆H₅CH₂NH—(O)C-Gly-LeuCF₃; CH₃NH—(O)C-Gly-IleH; CH₃CH₂NH—(O)C-Gly-IleH; C₆H₅CH₂NH—(O)C-Gly-IleH; CH₃NH—(O)C-Gly-IleCF₃; CH₃CH₂NH—(O)C-Gly-IleCF₃; C₆H₅CH₂NH—(O)C-Gly-IleCF₃; CH₃SO₂-Ala-LeuH; CH₃CH₂SO₂-Ala-LeuH; C₆H₅CH₂SO₂-Ala-LeuH; CH₃SO₂-Ala-LeuCF₃; CH₃CH₂SO₂-Ala-LeuCF₃; C₆H₅CH₂S₂-Ala-LeuCF₃; CH₃SO₂-Ala-IleH; CH₃CH₂SO₂-Ala-IleH; C₆H₅CH₂SO₂-Ala-IleH; CH₃SO₂-Ala-IleCF₃; CH₃CH₂SO₂-Ala-IleCF₃; C₆H₅CH₂SO₂-Ala-IleCF₃; CH₃SO₂-Gly-LeuH; CH₃CH₂SO₂-Gly-LeuH; C₆H₅CH₂SO₂-Gly-LeuH; CH₃SO₂-Gly-LeuCF₃; CH₃CH₂SO₂-Gly-LeuCF₃; C₆H₅CH₂SO₂-Gly-LeuCF³; CH₃SO2-Gly-IleH; CH₃CH₂SO₂-Gly-IleH; C₆H₅CH₂SO₂-Gly-IleH; CH₃SO₂-Gly-IleCF₃; CH₃CH₂SO₂-Gly-IleCF₃; C₆H₅CH₂SO₂-Gly-IleCF₃; CH₃O(OH)(O)P-Ala-LeuH; CH₃CH₂O(OH)(O)P-Ala-LeuH; C₆H₅CH₂O(OH)(O)P-Ala-LeuH; CH₃O(OH)(O)P-Ala-LeuCF₃; CH₃CH₂O(OH)(O)P-Ala-LeuCF₃; C₆H₅CH₂O(OH)(O)P-Ala-LeuCF₃; CH₃O(OH)(O)P-Ala-IleH; CH₃CH₂O(OH)(O)P-Ala-IleH; C₆H₅CH₂O(OH)(O)P-Ala-IleH; CH₃O(OH)(O)P-Ala-IleCF₃; CH₃CH₂O(OH)(O)P-Ala-IleCF₃; C₆H₅CH₂O(OH)(O)P-Ala-IleCF₃; CH₃O(OH)(O)P-Gly-LeuH; CH₃CH₂O(OH)(O)P-Gly-LeuH; C₆H₅CH₂O(OH)(O)P-Gly-LeuH; CH₃O(OH)(O)P-Gly-LeuCF₃; CH₃CH₂O(OH)(O)P-Gly-LeuCF₃; C₆H₅CH₂O(OH)(O)P-Gly-LeuCF₃; CH₃O(OH)(O)P-Gly-IleH; CH₃CH₂O(OH)(O)P-Gly-IleH; C₆H₅CH₂O(OH)(O)P-Gly-IleH; CH₃O(OH)(O)P-Gly-IleCF₃; CH₃CH₂O(OH)(O)P-Gly-IleCF₃; C₆H₅CH₂O(OH)(O)P-Gly-IleCF₃; CH₃O—(O)C-Val-Ala-LeuSO₃Na; C₆H₅CH₂O—(O)C-Gly-Ala-TyrH; C₆H₅CH₂O—(O)C-Gly-Ala-TyrSO₃H; C₆H₅CH₂O—(O)C-Gly-Ala-TyrSO₃Na; C₆H₅O—(O)C-Gly-Ala-TyrSO₃H; and C₆H₅O—(O)C-Gly-Ala-TyrSO₃Na. In the above compounds, the terminology described above will be used to identify the aldehyde or trifluoromethyl ketone groups, respectively.

In various embodiments, stereoisomers, such as enantiomers and diastereomers, tautomers and salts of the compounds described above may also be used.

In general, the peptide derivatives and peptide adducts used as stabilizers can be selected from those described in patent publications WO 2013/004636 A1, WO 2014/173980 A2, WO 2013/004635 A1, WO2014/124927 A3, WO2009/118375 A2, U.S. Pat. No. 6,165,966 A and US Pat US2011/0039752 A1.

In various embodiments, the detergent or cleanser is phosphate-free. “Phosphate-free” and “phosphonate-free,” as used herein, means that the composition in question is substantially free of phosphates or phosphonates, i.e. in particular phosphates or phosphonates in amounts less than 0.1 wt.-%, such as less than 0.01 wt.-%, based on the respective composition.

Further advantageous ingredients of detergents or cleansers are disclosed in international patent application WO2009/121725, starting at the next-to-last paragraph on page 5 and ending after the second paragraph on page 13. Reference is expressly made to this disclosure and the disclosure therein is incorporated in the present patent application by reference.

In general, the pH of the compositions can be adjusted by means of customary pH regulators. In various embodiments, the pH of the composition A is in a range of 5.5 to 8.5, such as 6.5 to 8.0, alternatively 7.0 to 7.5, i.e. about 7.5, and the pH of the composition B is in a range of 7.0 to 12, such as 8.0 to 11.5, alternatively greater than 8, i.e. 8.5 to 11.5. Acids and/or alkalis, such as alkalis are used as pH-adjusting means. Suitable acids are in particular organic acids such as acetic acid, citric acid, glycolic acid, lactic acid, succinic acid, adipic acid, malic acid, tartaric acid and gluconic acid or amidosulfonic acid. In addition, however, it is also possible to use the mineral acids hydrochloric acid, sulfuric acid and nitric acid or mixtures thereof. Suitable bases are selected from the group of alkali and alkaline earth metal hydroxides and carbonates, in particular the alkali metal hydroxides, of which potassium hydroxide may be used. In a non-limiting embodiment, the above-described alkali source is used to adjust the pH. Even if volatile alkali, for example in the form of ammonia and/or alkanolamines, which may contain up to 9 carbon atoms in the molecule, can be used to adjust the pH, wherein the alkanolamine can hereby be selected from the group consisting of mono-, di-, triethanol- and propanolamine and mixtures thereof, such volatile alkali sources may be avoided, especially ethanolamines. In various embodiments, therefore, the compositions contain less than 1.75 wt.-% alkanolamine, especially monoethanolamine, or even none of the alkanolamine. It has been found that omitting such alkanolamines increases the stability of the detergents or cleansers.

“Approximately,” as used herein in relation to a numerical value, means the numerical value ±5%. Thus, “about 7.5” means 7.125 to 7.875.

To adjust and/or stabilize the pH, the composition may contain one or more buffer substances (INCI buffering agents), usually in amounts of 0.001 to 5 wt.-%. Preference is given to buffer substances which are at the same time complexing builders or even chelating builders (chelators, INCI chelating agents). Non-limiting buffer substances are citric acid or citrates, in particular the sodium and potassium citrates, for example trisodium citrate.2H₂O and tripotassium citrate.H₂O.

The tailoring of the detergents or cleansers described herein can be done in different ways. The water- and/or organic solvent-based liquid forms of preparation may be present in thickened form in the form of gels.

In various embodiments, directly after preparation the detergent or cleanser or the respective liquid composition has a viscosity above 200 mPas (Brookfield Viscometer DV-II+Pro, spindle 25, 30 rpm, 20° C.), in particular between 400 and 6000 mPas.

The detergents and cleansers described herein may be prefabricated into dosage units. These dosage units may include the amount of washing or cleaning-active substances necessary for a cleaning cycle. Non-limiting dosage units have a weight of between 12 and 30 g. The volume of the aforementioned dosage units and their spatial form are selected with particular preference so that a dosing of the prefabricated units is ensured via the dosing chamber of a washing machine or dishwasher. The volume of the dosing unit is therefore from 10 and 35 ml, such as between 12 and 30 ml.

The detergents and cleansers, in particular the prefabricated dosage units, may have have a water-soluble shell.

The water-soluble shell may be made from a water-soluble film material, which is selected from the group consisting of polymers or polymer mixtures. The shell may be made up of one or of two or more layers of the water-soluble film material. The water-soluble film material of the first layer and of the additional layers, if present, may be the same or different. The films can be glued and/or sealed to packages such as hoses or cushions after being filled with a detergent or cleanser. In various embodiments, the films are in the form of multi-chamber pouches, with compositions A and B being spatially separated in different chambers of a pouch made of a water-soluble film.

The water-soluble shell may contain polyvinyl alcohol or a polyvinyl alcohol copolymer. Water-soluble shells containing polyvinyl alcohol or a polyvinyl alcohol copolymer exhibit good stability with a sufficiently high level of water solubility, in particular cold-water solubility.

Suitable water-soluble films for producing the water-soluble shell may be based on a polyvinyl alcohol or a polyvinyl alcohol copolymer, the molecular weight of which is in the range of from 10,000 to 1,000,000 gmol⁻¹, such as 20,000 to 500,000 gmol⁻¹, alternatively 30,000 to 100,000 gmol⁻¹, i.e. 40,000 to 80,000 gmol⁻¹.

Polyvinyl alcohol is usually produced by hydrolysis of polyvinyl acetate, since the direct synthesis route is not possible. The same applies to polyvinyl alcohol copolymers, which are prepared accordingly from polyvinyl acetate copolymers. At least one layer of the water-soluble shell may include a polyvinyl alcohol, the degree of hydrolysis of which is 70 to 100 mol.-%, such as 80 to 90 mol.-%, alternatively 81 to 89 mol.-%, i.e. 82 to 88 mol.-%.

In addition, a polymer selected from the group including (meth)acrylic acid-containing (co)polymers, polyacrylam ides, oxazoline polymers, polystyrene sulfonates, polyurethanes, polyesters, polyethers, polylactic acid or mixtures of said polymers may be added to a polyvinyl alcohol-containing film material that is suitable for producing the water-soluble shell. Polylactic acids may be used as an additional polymer.

Non-limiting polyvinyl alcohol copolymers include, in addition to vinyl alcohol, dicarboxylic acids as further monomers. Suitable dicarboxylic acids are itaconic acid, malonic acid, succinic acid and mixtures thereof.

Polyvinyl alcohol copolymers which include, in addition to vinyl alcohol, an ethylenically unsaturated carboxylic acid, or the salt or ester thereof, may be used. Polyvinyl alcohol copolymers of this kind may contain, in addition to vinyl alcohol, acrylic acid, methacrylic acid, acrylic acid ester, methacrylic acid ester or mixtures thereof.

The film material may contain further additives. The film material may contain plasticizers such as dipropylene glycol, ethylene glycol, diethylene glycol, propylene glycol, glycerin, sorbitol, mannitol or mixtures thereof, for example. Further additives include for example release aids, fillers, cross-linking detergents or cleansers, surfactants, anti-oxidants, UV absorbers, anti-blocking aids, anti-adhesive aids or mixtures thereof.

Suitable water-soluble films for use in the shells of the water-soluble packages are films which are sold by MonoSol LLC, for example under the names M8630, C8400 or M8900. Other suitable films include films named Solublon® PT, Solublon® GA, Solublon® KC or Solublon® KL from Aicello Chemical Europe GmbH, or VF-HP films from Kuraray.

Another object is a process for the cleaning of textiles or hard surfaces, which is characterized in that in at least one process step, an inventive detergent or cleanser is used. The subject of the present application is therefore in particular also a method for washing textiles in an automatic washing machine or for cleaning dishes in a dishwasher, wherein the detergent or cleanser is dosed into a washing machine or dishwasher during a washing or dishwashing program before the main wash cycle or during the main wash cycle. The dosing or the input of the detergent or cleanser into the washing machine or dishwasher can be done manually, or alternatively the detergent or cleanser can be dosed into the washing machine or dishwasher by means of the dosing chamber.

In various embodiments, the method described above is characterized in that the protease is used at a temperature of 0-100° C., such as 0-60° C., alternatively 20-40° C., i.e. at a temperature of 20° C.

These include both manual and automatic methods. Methods for cleaning textiles are generally characterized by the fact that, in a plurality of method steps, various cleaning substances are applied to the material to be cleaned and washed off after the exposure time, or in that the material to be cleaned is otherwise treated with a detergent or a solution or dilution of this detergent. The same applies to methods for cleaning all materials other than textiles, in particular hard surfaces. All conceivable washing or cleaning methods can be enhanced in at least one of the method steps by the use of a detergent or cleanser. All aspects, objects and embodiments described for the detergents and cleansers are also applicable to this subject matter. Therefore, reference is expressly made at this point to the disclosure at the appropriate point with the advice that this disclosure also applies to the above-described methods.

All aspects, objects and embodiments described for the detergents or cleansers are also applicable to this subject matter. Therefore, reference is expressly made at this point to the disclosure at the appropriate point with the advice that this disclosure also applies to the above-described uses and methods.

### EXAMPLES

### Formulations

Detergents or cleansers are listed below. These were packaged as detergent and cleanser portions in a water-soluble film.

Table 1 shows examples of detergents or cleansers E1 to E4, which were packaged in 2-chamber pouches of water-soluble polyvinyl alcohol film (data in wt.-% based on the respective chamber contents).

TABLE 1

| Detergent or | E1 | E2 | E3 | E4 |
|---|---|---|---|---|
| Chamber 1 (15g) | | | | |
| C₉₋₁₃- alkyl benzene | 21 | 21 | 21 | 21 |
| sulfonic acid | | | | |
| C₁₃₋₁₅ alcohol with | 22.5 | 22.5 | 22.5 | 18.5 |
| C₁₂₋₁₈ fatty acid | 17.5 | 17.5 | 17.5 | 17.5 |
| Glycerol | 11 | 12 | 10 | 11 |
| Phosphonic acid, Na salt | 0.3 | 0.3 | 0.3 | 0.3 |
| 1,2-propanediol | 13.5 | 13.5 | 10.5 | 10.5 |
| Ethanol | 3.26 | 3.26 | 3.26 | 3.26 |
| Monoethanolamine | 6.4 | 6.4 | 6.4 | 6.4 |
| NADP | + | + | + | + |
| β-Lapachone | 2 | 1 | 4 | 2 |
| Glucose dehydrogenase | + | + | + | + |
| Enzymes (amylases, | + | + | + | + |
| proteases, cellulases, | | | | |
| Dye | + | + | + | + |
| Soil release | — | — | 2 | — |
| Perfume | + | + | + | + |
| Optical brightener | 0.3 | 0.3 | 0.3 | 0.3 |
| Polyethyleneimine, ethoxylated | — | — | — | 5 |
| (Sokalan ® HP 20) | | | | |
| Water | 1.74 | 1.74 | 1.74 | 1.74 |
| Chamber 2 (10g) | | | | |
| C₉₋₁₃-alkyl benzene | 21 | 21 | 21 | 21 |
| sulfonic acid | | | | |
| C₁₃₋₁₅ alcohol with | 22.5 | 22.5 | 22.5 | 22.5 |
| C₁₂₋₁₈ fatty acid | 17.5 | 17.5 | 17.5 | 17.5 |
| Glycerol | 9 | 9 | 10 | 12 |
| Phosphonic acid, Na salt | 0.3 | 0.3 | 0.3 | 0.3 |
| 1,2-propanediol | 11.5 | 12.5 | 12.5 | 13.5 |
| Ethanol | 3.26 | 3.26 | 3.26 | 3.26 |
| MEA | 6.4 | 6.4 | 6.4 | 6.4 |
| Enzyme (A) | + | + | + | + |
| Glucose | 6 | 5 | 4 | 1 |
| Dicoumarol | + | — | + | — |
| Enzymes (amylases, | — | — | — | — |
| mannanases, pectate Ivases | | | | |
| Dye | + | + | + | + |
| Soil release | — | — | — | — |
| Perfume | + | + | + | + |
| Optical brightener | 0.3 | 0.3 | 0.3 | 0.3 |
| Sokalan HP 20 | — | — | — | — |
| Water | 1.74 | 1.74 | 1.74 | 1.74 |

c) Texcare ® SRN 170, Clariant

1. A detergent or cleanser comprising:
at least one quinone oxidoreductase;
an NAD(P)H cofactor; and
a first substrate for the at least one quinone oxidoreductase,
wherein the at least one quinone oxidoreductase is spatially separate from the NAD(P)H cofactor and the first substrate; and/or the detergent or cleanser further comprises at least one inhibitor of the at least one quinone oxidoreductase.

2. The detergent or cleanser according to claim 1, further comprising at least one glucose dehydrogenase suitable for the regeneration of the NAD(P)H cofactor and a second substrate for the glucose dehydrogenase.

3. The detergent or cleanser according to claim 1, wherein the detergent or cleanser comprises:
the at least one quinone oxidoreductase in an amount ranging from 0.00001 to 10 wt.-% based on the total weight of the detergent or cleanser;
the NAD(P)H cofactor in an amount ranging from 0.001 to 2 wt.-% based on the total weight of the detergent or cleanser;
the first substrate in an amount ranging from 0.1 to 10 wt.-%, based on the total weight of the detergent or cleanser;
the glucose dehydrogenase in an amount ranging from 0.00001 to 10 wt.-% based on the total weight of the detergent or cleanser;
the second substrate in an amount ranging from 0.2 to 10 wt.-% based on the total weight of the detergent or cleanser;
the inhibitor in an amount ranging from 0.00001 to 10 wt.-% based on the total weight of the detergent or cleanser; or
combinations thereof.

4. The detergent or cleanser according to claim 1, wherein the at least one quinone oxidoreductase comprises an amino acid sequence which, over its entire length, is at least 65% identical to the amino acid sequence given in SEQ ID NO:1, SEQ ID NO:2, or SEQ ID NO:3.

5. The detergent or cleanser according to claim 1, wherein the first substrate is a quinone selected from the group consisting of β-lapachone, streptonigrin, deoxynyboquinone, isobutyldeoxynyboquinone, mitomycin C, KP372-1, phenothiazinium compounds, 2,5-diaziridinyl-3-(hydroxymethyl)-6-methyl-1,4-benzoquinone (RH1), apaziquinone (EO9), indolequinones, pronoqodine A, quinolinequinones, binaphthylquinones, anthraquinone, plastoquinone, pyrroloquinoline quinone, carbazilquinone, chloranil, dibromothymoquinone, plastoquinone , ubiquinone, indolquinones, porfiromycin, pyrroliminoquinones, atovaquone, vitamin K, vitamin K1, vitamin K2, vitamin K3, or combinations thereof.

6. The detergent or cleanser according to claim 5, wherein the at least one inhibitor is a 4-hydroxycoumarin.

7. The detergent or cleanser according to claim 5, wherein the detergent or cleanser is in the form of a multi-chamber system; and wherein the at least one quinone oxidoreductase is in a different chamber of the multi-chamber system than the NAD(P)H cofactor and the first substrate.

8. The detergent or cleanser according to claim 2, wherein the detergent or cleanser is in the form of a multi-chamber system; and wherein the glucose dehydrogenase and the second substrate are present in different chambers of the multi-chamber system.

9. The detergent or cleanser according to claim 2, wherein the glucose dehydrogenase is glucose-6-phosphate dehydrogenase and the second substrate is glucose.

10. The detergent or cleanser according to claim 1, further comprising one or more components selected from the group consisting of builders, surfactants, polymers, water-miscible solvent, pH regulators, other enzymes, other enzyme stabilizers/inhibitors, bleaches, bleach catalysts, bleach activators, foam regulators, dyes, fragrances, perfume carriers, or combinations thereof.

11. The detergent or cleanser according to claim 1, wherein the detergent or cleanser is:
liquid;
in the form of a unit dosage;
phosphate-free; or
combinations thereof.

12. A method for washing textiles or automatic cleaning of dishes, wherein the method comprises:
applying a detergent or cleanser according to claim 1 to the textiles or dishes.
